(19) United States
(12) Patent Application Publication
(10) Pub. No.: US 2020/0410758 A1
(43) Pub. Date: Dec. 31, 2020

(54) Augmented Reality Greeting Card and Gift

(71) Applicant: Wells Fargo Bank, N.A., San Francisco, CA (US)

(72) Inventor: Robert Glenn Hamchuk, San Jose, CA (US)

(21) Appl. No.: 15/862,409

(22) Filed: Jan. 4, 2018

Related U.S. Application Data
(60) Provisional application No. 62/609,484, filed on Dec. 22, 2017.

(51) Int. Cl. G06T 19/00; G06Q 20/34; H04W 4/024; G06K 9/00; G06Q 30/06; H04L 12/58

(52) U.S. Cl. CPC G06T 19/006; G06Q 20/351; H04L 51/08; H04W 4/024; G06K 9/00671; G06Q 30/0631

(57) ABSTRACT

A method for creating an electronic greeting card includes receiving a selection of a theme and a message for the electronic greeting card. A selection is received of a theme and a message for the electronic greeting card. A selection is received of one or more retailers from which gifts can be obtained using the electronic greeting card. A recommendation is received for one or more products that can be selected from at least one of the one or more retailers. The theme, the message, identifiers for each of the one or more retailers and identifiers for at least one of the one or more products are integrated into the electronic greeting card.

### BACKGROUND

Many people like to send greeting cards to friends and relatives to commemorate a special occasion, to express thanks to a recipient or for other reasons. The greeting cards typically include a greeting, such as an expression of well-wishes or thanks and commonly include a monetary gift, either cash or a gift card for a particular retailer.

Electronic greeting cards are becoming increasingly popular. The electronic greeting cards can be purchased at on online site and can also include both a greeting and a gift.

### SUMMARY

Embodiments of the disclosure are directed to a method implemented on an electronic computing device for creating an electronic greeting card, comprising: receiving a selection of a theme and a message for the electronic greeting card; receiving a selection of one or more retailers from which gifts can be obtained using the electronic greeting card; receiving a recommendation for one or more products that can be selected from at least one of the one or more retailers; and integrating into the electronic greeting card the theme, the message, identifiers for each of the one or more retailers and identifiers for at least one of the one or more products.

In another aspect, a method implemented on an augmented reality (AR) electronic device comprises: detecting that the AR electronic device is in a proximity of a retail store identified on an electronic greeting card; activating the electronic greeting card on the AR electronic device; and as a result of activating the electronic greeting card on the AR electronic device when the AR electronic device is in a proximity of the retail store: automatically displaying on the AR electronic device identifiers or images of one or more items preselected for purchase on the electronic greeting card at the retail store; receiving a selection of one of the one or more items; and displaying a floor plan of the retail store with details regarding where to locate the selected item in the retail store.

In yet another aspect, an electronic computing device comprises: a processing unit; and system memory, the system memory including instructions which, when executed by the processor, cause the electronic computing device to: receive a selection of a theme and a message for an electronic greeting card; receive a photograph from a purchaser of the electronic greeting card; receive a selection of one or more retailers from which gifts can be obtained using the electronic greeting card; receive a list of recommended products for the electronic greeting card from the purchaser of the electronic greeting card; obtain a pointer to a storage area that includes information regarding the theme, message, photograph, selection of the one or more retailers and the list of recommended products for the electronic greeting card; integrate into the electronic greeting card the theme, the message, the photograph, identifiers for each of the one or more retailers and the list of recommended products; add a hyperlink to the electronic greeting card, the hyperlink providing a link to a website that can activate the electronic greeting card; and send an email message or a text message to a recipient of the electronic greeting card, the email message or text message including the hyperlink.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports an augmented reality greeting card.

FIG. 2 shows example modules of the greeting card creation engine of FIG. 1.

FIG. 3 shows example modules of the greeting card processing engine of FIG. 1.

FIG. 4 shows an example greeting card that can be rendered on the recipient electronic computing device of FIG. 1.

FIG. 5 shows an example view of a floor plan of a retail store that can be rendered on the recipient electronic computing device of FIG. 1.

FIG. 6 show an example user interface screen that can be rendered on the customer electronic computing device of FIG. 1.

FIG. 7 shows an example method for creating an electronic greeting card.

FIG. 8 shows an example method for redeeming a gift in a retail store using the electronic greeting card of FIG. 7.

FIG. 9 shows example physical components of the greeting card company server computing device of the system of FIG. 1.

### DETAILED DESCRIPTION

The present disclosure is directed to systems and methods for an electronic greeting card that can be activated on an augmented reality (AR) electronic device. The electronic greeting card can be created via a software application on a mobile electronic device, such as a smartphone. A user can use the software application to select a template for the card, select a greeting for the card, select one or more gift products from participating retailers and select a monetary value for the gift. The monetary value can be designated for a specific selected gift or can be a used to purchase any product(s) of the recipient's choice at the participating retailers, up to the monetary value of the gift. The monetary value can also be designated as a cash amount to be used as a cash card wherever the cash card is accepted.

When the recipient enters a retail store of a selected participating retailer, any gifts authorized for the card and offered by the participating retailer are displayed on the AR electronic device of the recipient. When the recipient selects an authorized gift on the AR electronic device, a floor map of the retail store can be displayed on the AR electronic device. As discussed in more detail later herein, the floor map display can guide the recipient to where the authorized gift is located in the retail store.

The systems and methods can also be used to inform the purchaser of the greeting card of any items purchased by the recipient using the greeting card. This information can provide feedback to the purchaser as to how the greeting card is used. The feedback can let the purchaser know whether any gifts recommended by the purchaser were actually purchased. The feedback can also give the purchaser information regarding any future recommended gifts for the recipient.

The systems and methods also permit the purchaser of the greeting card to personalize the greeting card with one or more photos and/or special effects. For example a photograph of the purchaser can be uploaded and included on the greeting card. Filters can be used to add special effects, such as a party hat, streamers, costumes, a birthday cake, etc.

When the greeting card is personalized and retailers, products and a gift amount have been selected, an electronic wizard can be used to create the greeting card. The electronic wizard can be part of the software application for the greeting card or the electronic wizard can be separate from the software application. In some implementations, the greeting card can be created on a server computing device and the electronic wizard can be a software application that runs on the server computing device.

The AR electronic device can be a smartphone that includes an augmented reality software application. Alternatively, the AR electronic device can be an AR headset that may be worn by recipient.

The AR headset includes a wearable computer, a camera and an optical display. The wearable computer includes a wireless telecommunication capability, permitting a wireless connection between the wearable computer and one or more server computing devices. The wearable computer also includes voice recognition capability, permitting the user to direct the wearable computer via voice commands. In addition, in some implementations, the wearable computer also includes biometric capability such as facial recognition, retinal scan capability, finger print and voice print capability. The biometric capability permits biometric authentication of the user, as described in more detail later herein.

One type of AR headset described in this disclosure is a smart glass type of headset, similar to eyeglasses, that may be worn by the recipient. The recipient can view the floor plan of the retail store and images from the greeting card in the glass portion of the headset. An example of a smart glass headset is Google Glass, from Google Inc. of Mountain View, Calif.

In this disclosure, greeting card denotes an electronic greeting card that also includes a gift portion. The gift portion can identify one more participating retailers from which gifts can be obtained using the electronic greeting card. The gift portion can also, or alternatively include, a generic gift card in which the recipient can obtain gifts at any retailer that accepts the generic gift card.

The systems and methods disclosed herein are directed to a computer technology that can permit a user at an augmented reality electronic device to automatically access an electronic greeting card and automatically locate and obtain a product using the electronic greeting card in a retail store. The computer technology can automatically determine when a recipient of the electronic greeting card is at a location of a participating retail store. In addition, the computer technology can implement a technical effect of automatically displaying a floor plan of the retail store on a display screen of the augmented reality electronic device and automatically direct the recipient to the location of the product using visual indicators on the display screen. In addition, the computer technology can automatically alter a display of the floor plan to correspond to what the recipient sees as the recipient walks towards the product in the retail store. Further, the computer technology can perform this technical effect for any retail store of a participating retail identified on the greeting card, automatically displaying the correct floor map for the retail store based on a GPS location of the recipient.

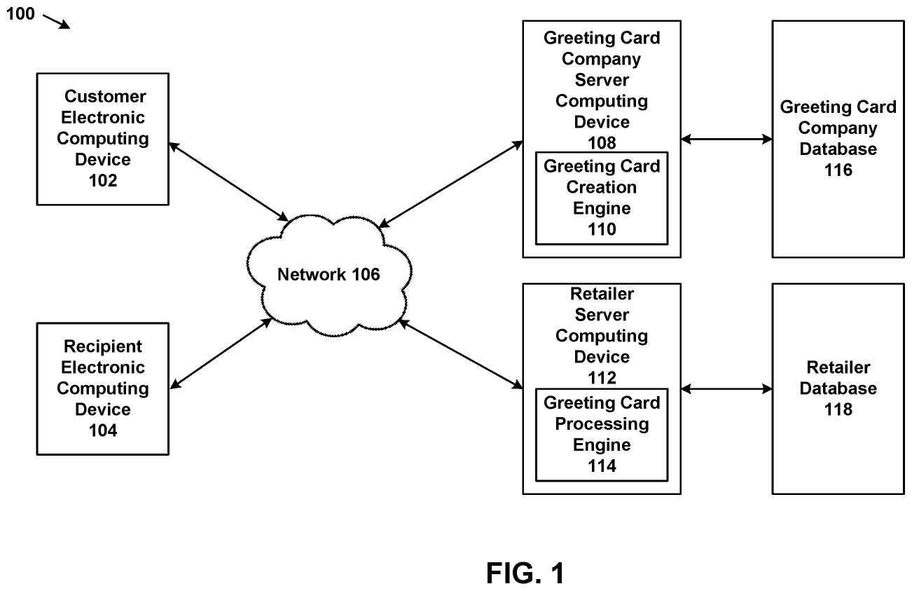

FIG. 1 shows an example system 100 that can support an augmented reality greeting card. System 100 includes customer electronic computing device 102, recipient electronic computing device 104, network 106, greeting card company server computing device 108, retailer server computing device 112, greeting card company database 116 and retailer database 118. Greeting card company server computing device 108 includes greeting card creation engine 110. Retailer server computing device includes greeting card processing engine 114. More, fewer or different components are possible. In some implementations, for example when a retailer decides to issue electronic greeting cards, greeting card company server computing device 108 and retailer server computing device 112 can be the same server computing device.

The example customer electronic computing device 102 is an electronic computing device of an individual who purchases an electronic greeting card. The electronic computing device can be one of a desktop computer, a laptop computer or a mobile computing device such as a tablet computer or a smartphone. Customer electronic computing device 102 includes a software application that permits the individual to select options for the electronic greeting card. More than one customer electronic computing device 102 can be used.

The example recipient electronic computing device 104 is an electronic computing device of the recipient of the greeting card. The recipient electronic computing device 104 includes augmented reality functionality, which can comprise an augmented reality software application on a mobile computing device such as a smartphone. Alternatively, the augmented reality functionality can be provided by an AR headset, as described earlier herein. The recipient electronic computing device 104 can be used at a retail store by the recipient of the electronic greeting card to select, locate and obtain a gift item in the retail store.

The example network 106 is a computer network such as the Internet. Customer electronic computing device 102 and recipient electronic computing device 104 can communicate with greeting card company server computing device 108 and retailer server computing device 112 using network 106.

The example greeting card company server computing device 108 is a server computing device of a company that sells electronic greeting cards over the Internet. In some implementations, greeting card company server computing device 108 can be a web server that hosts a website for electronic greeting cards. An individual can activate a software application for the company on customer electronic computing device 102 and access the website to create a personalized electronic greeting card.

The example greeting card creation engine 110 processes customer selections to create the electronic greeting card. Greeting card creation engine 110 permits a customer to select a template for the greeting card, a message for the greeting card, one or more participating retailers, and one or more gifts than can be purchased at the one or more participating retailers. Greeting card creation engine 110 also permits the greeting card to be personalized with personal photos and using filters that can add accessory items to the photos and templates. Example accessory items can include party hats, streamers, school emblems, sports emblems, landscape backgrounds and other accessory items.

The example retailer server computing device 112 is a server computing device of a participating retail company that provide products for the greeting card that can be purchased using the greeting card at a retail store location of the participating retail company. When a recipient of the greeting card enters a participating retail store, a communication can be established between an AR electronic device of the recipient and retailer server computing device 112. As a result of the communication, a product can be selected from the greeting card and a floor map of the retail store can be displayed on the AR electronic device to help the recipient locate the product.

The example greeting card processing engine 114 facilitates a redemption of the greeting card by the recipient at the participating retail store. The greeting card processing engine 114 can access an electronic cart for the recipient that includes information regarding the greeting card. The electronic cart provide a link to a storage area that stores the information. In addition, as discussed in more detail later herein, the greeting card processing engine 114 can process a gift selection of the recipient, identify the participating retail store, locate the product in the participating retail store, obtain an electronic floor map for the participating retail store and display the electronic floor map on an AR electronic device of the recipient at the retail store.

The example greeting card company database 116 is a database associated with the greeting card company. Information regarding card templates, filters, participating retailers and products offered by the participating retailers can be stored in greeting card company database 116. In addition, greeting card company database 116 can store customer information including photographs submitted by the customer and records of greeting cards purchased by the customer. Greeting card company database 116 can be distributed over a plurality of databases. The greeting card creation engine 110 can be programmed to query (e.g. using SQL) greeting card company database 116 to obtain data relating to the greeting card, as discussed in more detail later herein.

The example retailer database 118 is a database of a retailer that participates in a gift program offered by the greeting card company. Retailer database 118 can store information regarding brick and mortar retail stores in which the recipient of the greeting card can obtain merchandise. The information can include an address of the retail store and a floor map than can display where products are located in the retail store. The information can also include an identifier for greeting card. The identifier can access a record of products that may have been recommended to the recipient on the greeting card and a dollar amount remaining on the greeting card. Other information can be stored in retailer database 118, including a recipient record which can identify any items actually obtained by the recipient using the greeting card and which can provide feedback to the purchaser of the greeting card as to how the greeting card is used. The greeting card processing engine 114 can be programmed to query (e.g. using SQL) retailer database 118 to obtain data relating to the greeting card, as discussed in more detail later herein.

An example schema of information stored in greeting card company database 116 is shown below:
Customer ID;
Customer name;
Customer address;
Customer telephone number;
Customer email address;
Recipient name;
Recipient email address;
Gift allocated dollar amount;
Gift remaining dollar amount;
Pointer to screen data for greeting display area;
Number of selected retailers;
Retailer 1 identifier;
Pointer to retailer 1 available product categories;
Pointer to retailer 1 recommended products;
. . .
Retailer n identifier;
Pointer to retailer n available product categories;
Pointer to retailer n recommended products;
Pointer to products obtained at retailer;

The above schema permits greeting card company database 116 to be queried for data such as an allocated dollar amount of the greeting card, a dollar amount remaining on the greeting card, participating retailers for the greeting card, products recommended by the customer and products obtained by the recipient. Other data can be queried.

For example, the following messaging format can be used between the greeting card company server computing device 108 and greeting card company database 116 to obtain information regarding products recommended by the customer at a specific retailer.

| | | |
|---|---|---|
| Customer ID | Retailer ID | Recommended Products |

The greeting card company database 116 can use the following messaging format in responding to such a request.

| | | | | |
|---|---|---|---|---|
| Customer ID | Number of | Description of | Description of | . . . |
| | recommended | first | second | |
| | products | recommended | recommended | |
| | | product | product | |

Similar message formats can be used for other fields.

An example schema of inventory information stored in retailer database 118 is shown below:
Number of retail stores;
Identifier for first retail store;
Address of first retail store;
Pointer to floor plan of first retail store;
. . .
Pointer to floor plan for last retail store;
Number of recipients;
Recipient 1 ID;
Pointer to electronic cart of recipient 1;
Identifier of retail store at location of recipient 1;
Identifier for product selected by recipient 1;
Location of product selected by recipient 1;
. . .
Recipient n ID;
Pointer to electronic cart of recipient n;
Identifier of retail store at location of recipient n;
Identifier for product selected by recipient n;
Location of product selected by recipient n;

The above schema permits retailer database 118 to be queried for data such as a floor plan for a specific retail store and a location of a specific product at the retail store. Other data can be queried.

For example, the following messaging format can be used between the retailer server computing device 112 and retailer database 118 to obtain information regarding a floor plan at a specific retail store.

| | | |
|---|---|---|
| Recipient ID | Retailer ID | Floor Map |

The retailer database 118 can use the following messaging format in responding to the request for the floor map.

| | |
|---|---|
| Retailer ID | Pointer to floor map |

As another example, the following messaging format can be used between the retailer server computing device 112 and retailer database 118 to obtain information regarding a location of a product at a specific retail store.

| | | |
|---|---|---|
| Recipient ID | Retailer ID | Product ID |

The retailer database 118 can use the following messaging format in responding to the request for the floor map.

| | |
|---|---|
| Retailer ID | Product locator data |

Similar message formats can be used for other fields.

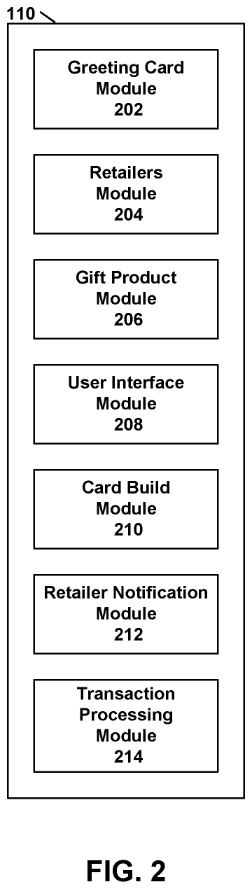

FIG. 2 shows example modules of greeting card creation engine 110. The example modules include a greeting card module 202, a retailers module 204, a gift product module 206, a user interface module 208, a card build module 210, a retailer notification module 212 and a transaction processing engine 214. More, fewer or different modules are possible.

The example greeting card module 202 provides access to templates, filters, uploaded photographs and other items to format a greeting card for a customer. The templates, filters, uploaded photographs and other items can be obtained from greeting card company database 116 or from a storage location on greeting card company server computing device 108. The templates can provide a background and theme for the greeting card. The filters can be used to add special effects to the templates or to personal photographs uploaded by the customer.

The example retailers module 204 provides information regarding retailers that are participating in the gift program offered by the greeting card company. Each participating retailer has at least one brick and mortar retail store in which a recipient of the greeting card can obtain a product offered at the retail store using the greeting card. The information provided to retailers module 204 can include an identifier for the participating retailer and identification information for each participating brick and mortar retail store of the participating retailer. The identification information can include the name, address and contact information for each participating brick and mortar retail store and gift products available at each participating brick and mortar retail store.

The example gift product module 206 provides information regarding gift products offered by the participating retailers. For example gift product module 206 can provide a list of available gift products and which participating retailers carry the available gift products. The list of available gift products and the participating retailers can be provided to card build module 210 and formatted onto the greeting card.

The example user interface module 208 renders a user interface for the software application for the greeting card on customer electronic computing device 102. The user interface can be displayed when the customer activates the software application for the greeting card on customer electronic computing device 102. The user interface can permit the customer to select a template, filters, products and retailers for the greeting card. The user interface is described in more detail later herein.

The example card build module 210 uses information from greeting card module 202, retailers module 204, gift product module 206 and customer selections from user interface module 208 to build and format the greeting card. Building and formatting the greeting card can comprise integrating a theme, message, photograph, identifiers for one or more retailers and identifiers for recommended products into the greeting card. The identifiers for the recommended products can be a list of recommended gifts offered by one or more of the retailers, names of the recommended gifts or other identifiers. Once built and formatted, the greeting card can be rendered on the software application for the greeting card on customer electronic computing device 102. The customer can view the greeting card and either accept it for purchase or modify it before purchasing.

The example retailer notification module 212 sends a notification to a retailer selected for the greeting card. The notification informs the retailer that a greeting card that includes the retailer has been processed and paid for. The notification can include an identifier for the greeting card and can also include a name or other information for retailer products that have been suggested for the greeting card. The identifier for the greeting card can be used by the greeting card company to store and lookup details regarding the greeting card, similar to an electronic cart used by online retailers. The retailer can store a record with the information in the notification in retailer database 118 and can assign a unique identifier for this record. The unique identifier be used to locate the record when the recipient of the greeting card enters a retail store of the participating retailer to redeem the card.

The example transaction processing engine 214 can receive information when transactions are made using the greeting card. The information can contain details about any products obtained using the greeting card, the retail store at which the redemption occurred and the cost of the product. Greeting card company database 116 can be updated with the information. In addition, retailer notification module 212 can send a notification message to each retailer selected on the card to update the record for the card in the retailer database 118. For example, an amount left to spend on the card can be updated to reflect redemption of the product.

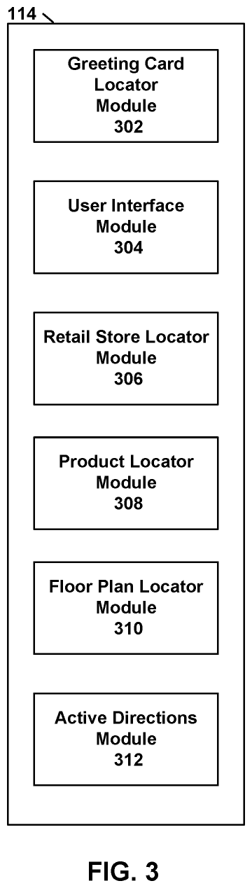

FIG. 3 shows example modules of greeting card processing engine 114. The example modules include a greeting card locator module 302, a user interface module 304, a retail store locator module 306, a product locator module 308 and a floor plan locator module 310 and an active directions module 312. More, fewer or different modules are possible.

The example greeting card locator module 302 receives a notification that a recipient of a greeting card is in a brick or mortar retail store of the participating retailer associated with retailer server computing device 112. The greeting card locator module 302 can then access retailer database 118 to access a record for the greeting card stored on retailer database 118.

The example user interface module 304 uses information in the record for greeting card to render details regarding the gift portion of the greeting card on recipient electronic computing device 104. The details can include a display of the recommended products for the gift portion and a dollar amount left to spend on the greeting card. In some implementation, the user interface module 304 can also render a search button on recipient electronic computing device 104 that can permit the recipient to search for products other than those recommended, but available for gift redemption in the retail store. The user interface module can also render a floor plan for the retail store and render visual directions to where a selected product is located in the retail store, as discussed in more detail later herein.

The example retail store locator module 306 receives a geolocation of recipient electronic computing device 104 and uses the geolocation to identify a retail store in which the recipient is currently located. The geolocation can be obtained using global positioning system (GPS) software on recipient electronic computing device 104.

The example product locator module 308 locates a selected product in the retail store. When the recipient selects a product for redemption using the user interface, an identifier for the product can be sent to retailer server computing device 112 and to product locator module 308. Product locator module 308 can then determine a location of the product in the retail store from information stored in retailer database 118.

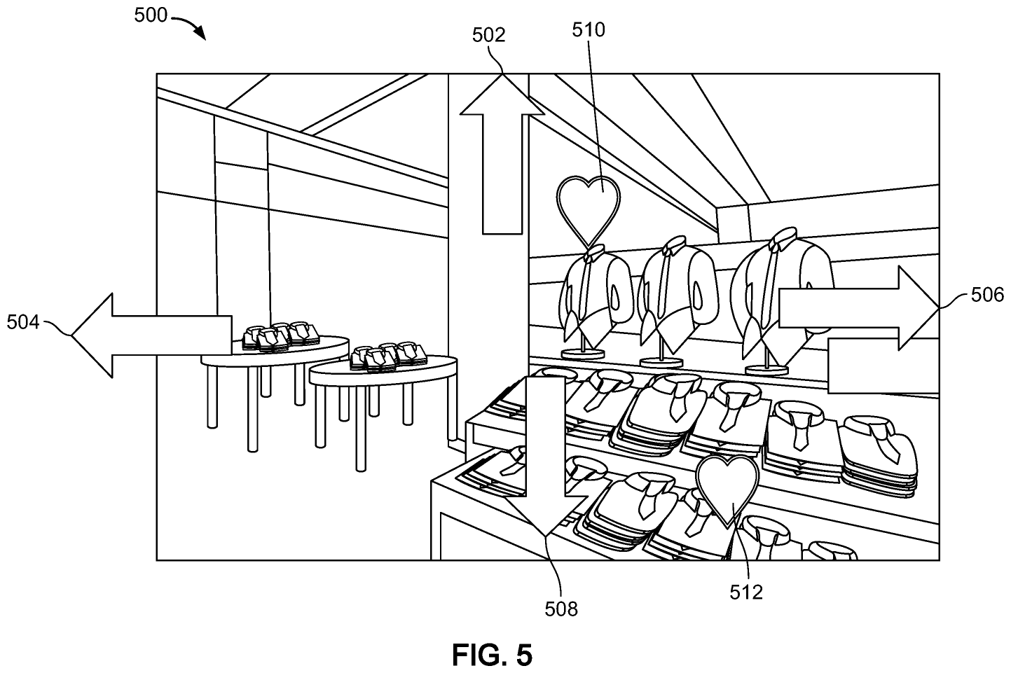

The example floor plan locator module 310 can access retailer database 118 to obtain a floor plan of the retail store. When the floor plan is obtained, user interface module 304 can display on recipient electronic computing device 104 a view of the retail store as seen at a current location of the recipient in the retail store. An example view of the retail store using the floor plan is shown in FIG. 5 and discussed in more detail later herein.

The example active directions module 312, can provide active visual directions to guide the recipient from the current location of the recipient to where the selected product is located in the retail store. As discussed in more detail later herein with respect to FIG. 5, arrows or other visual indicators can be used to guide the recipient to where the product is located in the retail store.

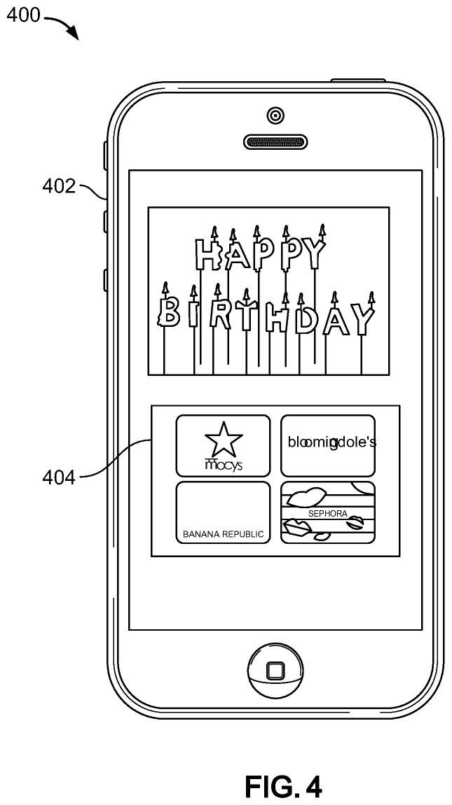

FIG. 4 shows a screen shot 400 of an example greeting card that can be rendered on recipient electronic computing device 104. Screen shot 400 can be rendered on recipient electronic computing device 104, for example, when the recipient receives a text message or email message with a link to the greeting and gift card and the recipient clicks on the link.

The example screen shot 400 includes an upper section 402 that includes a greeting and a lower section 404 that includes gift information. As shown in FIG. 4, the greeting is “Happy Birthday.” Also shown in the background are candles commemorating the birthday. The lower section 404 shows example credit cards from four retailers—Macy's, Bloomingdales, Banana Republic and Sephora, signifying that gifts can be selected from any one of these four retailers. When the user selects one of the retailers, in some implementations another screen shot is displayed with one or more recommended products for the selected retailer. This screen shot can also include a message from a purchaser of the recipient recommending the one or more products.

The example greeting card shown in FIG. 4 can be created on customer electronic computing device 102 by the purchaser of the card. The “Happy Birthday” greeting can be selected from one of the themes available on the software application for the greeting card. The candles in the background can be selected from filters available on the software application or can be included as part of the theme.

FIG. 5 shows a screen shot 500 of a section of a retail store. The section of the retail store can comprise a view seen by the recipient at recipient electronic computing device 104. For example, when recipient electronic computing device 104 is an AR headset, the view shown in FIG. 5 can comprise the view seen by the recipient via the display portion of the AR headset. When recipient electronic computing device 104 is a smartphone running an AR software application, the view shown in FIG. 5 can comprise the view seen by the recipient when viewing the display using the AR software application.

Screen shot 500 also includes four example directional arrows, 502, 504, 506 and 508 that can actively direct the recipient to a selected product. In one implementation, the arrow corresponding to a direction the recipient is to walk can change color or flash. In other implementation, only one directional arrow may be displayed, corresponding to the direction in which the recipient is to walk to the product. As the recipient proceeds to walk to the product, the directional arrow can continually indicate a correct direction in which to walk. FIG. 5 also shows two heart-shaped indicators, 510 and 512, which point to products recommended for the recipient. In some implementations, other indicators besides hearts can be used. In addition, more or fewer indicators can be used, depending on a number of recommended products within a view on the AR headset.

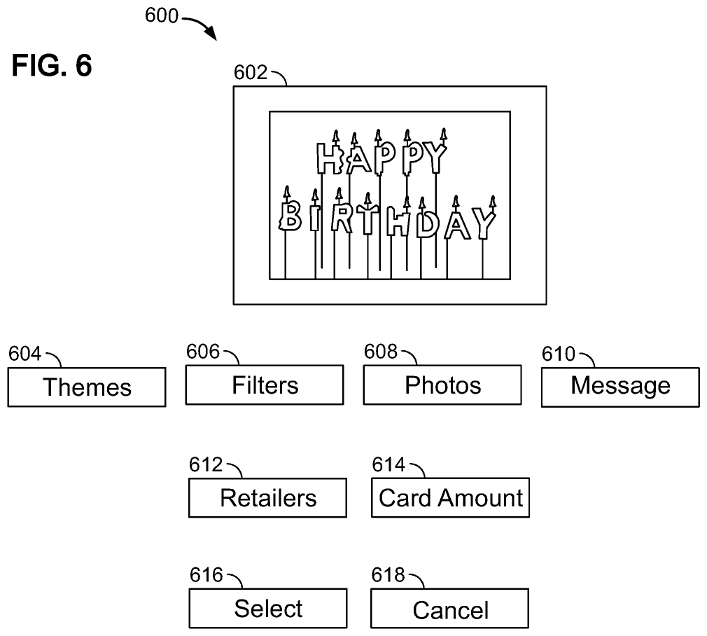

FIG. 6 is a screen shot of an example user interface 600 that can be used for creating the greeting card. User interface 600 is activated when the customer at customer electronic computing device 102 uses the software application for the greeting card on customer electronic computing device 102 to access a website of the greeting card company and select a control on the website for creating the greeting card.

User interface 600 includes a display area 602 for building and displaying the greeting section of the greeting card. Themes, filters, a message and photos can be added to the greeting section via controls for themes 604, filters 606, photos 608 and message 610.

In an example implementation, the themes 604 control can comprise a pull-down list box that can list available themes. Some available themes are birthday, anniversary, graduation and congratulations. Some specific themes that can be selected are happy birthday, happy anniversary, congratulations high school graduate, congratulations college graduate and congratulations on your promotion. Other themes are possible. When a theme is highlighted on the pull-down list box and the select 616 control is selected, an image corresponding to the theme is displayed in display area 602.

The filters 606 control can be used to add special effects to the image displayed in display area. In an example implementation, the filters 606 control can comprise a pull-down list box that can list available filters. Example filters that can be selected can include party hats, streamers, balloons, a cake and a diploma. Other filters are possible. When a filter is highlighted on the pull-down list box and the select 616 control is selected, the filter can be added to the display area 602. Once the filter has been added to the display area 602, the filter can be moved around and adjusted in size to create an intended effect.

The photos 608 control permits personalized photos to be uploaded to the display area 602. When the photos 608 control is selected, a dialog box can be displayed from which the customer can select one or more available photos for uploading. When an available photo is highlighted and the select 616 control is selected, the highlighted photo is uploaded to the display area 602. Once the photo has been added to the display area 602, the photo can be moved around in the display area and adjusted in size. In addition, filters can be used to add special effects to the photo, such as a party hat. Other filter items can be added to the photo.

The message 610 control permits a message to be added to the display area 602. The message can be one of an available selectable message or the message can be a personalized message. In an example implementation, message 610 control can comprise a pull-down list box from which the customer can selected a specific message or an option for a personalized message. When a specific message is highlighted and the select 616 control is selected, the selected message is displayed on the display area 602, moved around and resized. When the personalized option is selected and the select 616 control is selected, a dialog box can be displayed from which the customer can create a personalized message to the display area 602.

The example retailers 612 control permits the customer to select one or more participating retailers from which the recipient of the greeting card can select gifts. In an example implementation, when the retailers 612 control is selected, a list box listing available participating retailers can be displayed. When a participating retailer is highlighted and the select 616 control is selected, another list box is displayed listing available categories of products that can be selected for the participating retailer. When an available category is highlighted, another list box can be displayed listing specific products, including prices, in the selected category that are available from the participating retailer. When the customer selects one or more specific products, these specific products can be listed on the greeting card as specific products recommended by the customer. In addition, in this example implementation, when a participating retailer is selected, an image of a credit card of the participating retailer is displayed on the greeting card, similar to the images of credit cards displayed in FIG. 4.

The example card amount 614 control permits the customer to select a specific dollar amount of items that can be obtained using the greeting card. The dollar amount can be applied to one item or to a plurality of items. In addition, the dollar amount can be used for any available item from a selected participating retailer and not just items recommended by the customer.

The select 616 control permits a selection of a highlighted item. The cancel 618 control permits canceling an operation. For example, if the customer decides to add a filter and then decides not to add the filter, selecting the cancel 618 control cancels the filter operation and clears the display screen of the filter pull-down list box.

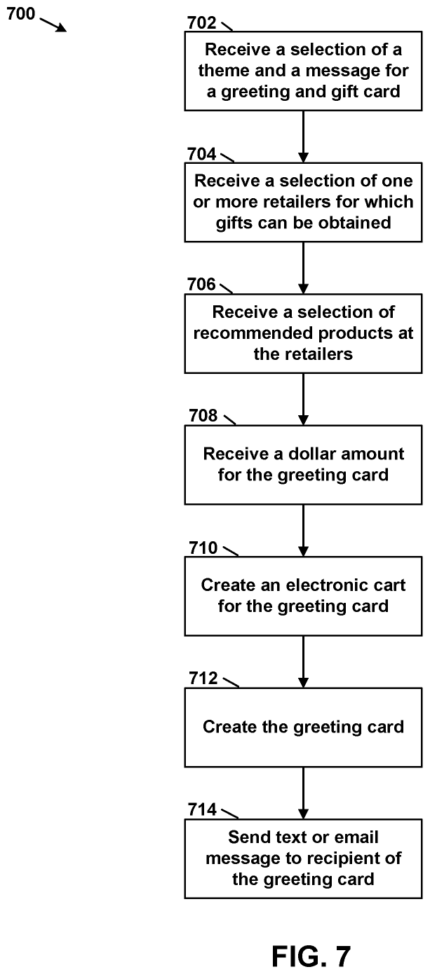

FIG. 7 shows a flowchart for an example method 700 for creating a greeting card at greeting card company server computing device 108. The greeting card is created by a customer of the greeting card company at customer electronic computing device 102 using a software application for the greeting card company.

At operation 702, greeting card company server computing device 108 receives a selection of a theme and a message for the greeting card. The theme can be selected from a plurality of themes available at the software application. The message can be one of a plurality of available messages or the message can be a personalized message. Example themes can provide a name of the theme and a background corresponding to the theme, such as Happy Birthday showing candles in each letter of Happy Birthday. The message can be a stored message such as Congratulations or the message can be personalized. In some examples, when the message is already part of the theme, such as in Happy Birthday, an additional message is not necessary.

At operation 704, greeting card company server computing device 108 receives a selection of one or more retailers for which gifts can be obtained using the greeting card. The selection can be made from a menu of participating retailers that can be displayed on customer electronic computing device 102.

At operation 706, greeting card company server computing device 108 receives a selection of recommended products available from the participating retailers selected at operation 704. When the greeting card is created, a list of the recommended products can be included and can be presented to the recipient of the greeting card as products recommended by the customer.

At operation 708, a dollar amount is received for the greeting card. The dollar amount indicates a total dollar amount of items that can be obtained at the participating retailers using the greeting card.

At operation 710, an electronic cart is created for the greeting card. The electronic cart comprises a storage area for details regarding the greeting card. The details can include information regarding the greeting, the participating retailers, any recommended products, the dollar amount and the format of the greeting card. A link to the electronic cart can be added to the greeting card when the greeting card is created. When the recipient of the greeting card clicks on the link, the greeting card can be displayed to the recipient.

At operation 712, the greeting card is created. The greeting card is created using selected information regarding the theme, message, retailers, recommended products and electronic cart. An example greeting card is shown in FIG. 4.

At operation 714, a text or email message is sent to the recipient of the greeting card. The text or email message includes a hyperlink to the greeting card. The hyperlink can access a webpage on a server computing device that can activate the greeting card. When the hyperlink is selected, the greeting card is displayed on recipient electronic computing device 104.

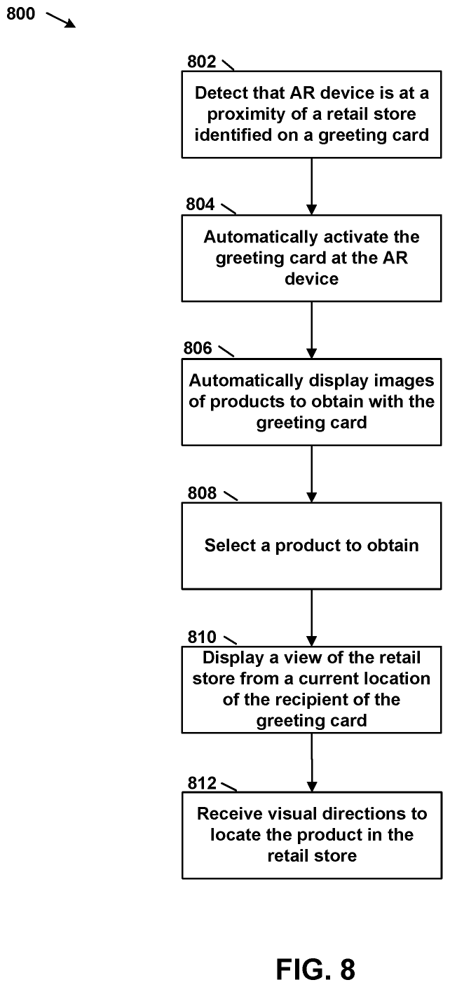

FIG. 8 shows a flowchart for an example method 800 implemented on recipient electronic computing device 104 for redeeming a greeting card at a retail store. Method 800 assumes that the recipient of the greeting card is carrying an AR electronic device, for example recipient electronic computing device 104, on which the greeting card has been received. Method 800 also assumes that the recipient is at a location in a proximity of a retail store of a participating retailer specified on the greeting card.

At operation 802, recipient electronic computing device 104 detects that the recipient is in the proximity of the participating retailer specified on the greeting card. GPS software on recipient electronic computing device 104 can detect when recipient electronic computing device 104 is at a geolocation of a retail store of a participating retailer.

At operation 804, when recipient electronic computing device 104 detects that recipient electronic computing device 104 is at the geolocation of the retail store of the participating retailer, recipient electronic computing device 104 automatically activates the greeting card at the AR device. Automatically activating the greeting card on recipient electronic computing device 104 comprises sending a message to retailer server computing device 112 with the hyperlink for the electronic cart associated with the greeting card.

At operation 806, images of recommended products that can be obtained with the greeting card at the retail location are displayed on recipient electronic computing device 104. In addition, a control from which the recipient can search for other available products at the retail store is displayed on recipient electronic computing device 104.

At operation 808, the recipient at recipient electronic computing device 104 makes a selection of an item for redemption, either a product recommended by the purchaser of the greeting card or another available product at the retail store. The selection of the product is then sent to retailer server computing device 112.

At operation 810, a view of the retail store from a current location of the recipient of the greeting card is displayed in augmented reality on recipient electronic computing device 104. The view is provided by retailer server computing device 112. When retailer server computing device 112 receives the geolocation of the retail store, retailer server computing device 112 can obtain a floor plan of the retail store from retailer database 118. In addition, retailer server computing device 112 can obtain a location in the retail store of the product selected by the recipient. Retailer server computing device 112 can send both the floor plan and the location of the product to recipient electronic computing device 104.

At operation 812, visual directions to the selected product can be projected in augmented reality on recipient electronic computing device 104. The directions can comprise one or more arrows that can show a direction that the recipient needs to walk from the current location of the recipient to a location in the retail store where the product is located. In addition, when the recipient walks towards the product, a view of the retail store that the recipient sees is displayed in augmented reality on recipient electronic computing device 104.

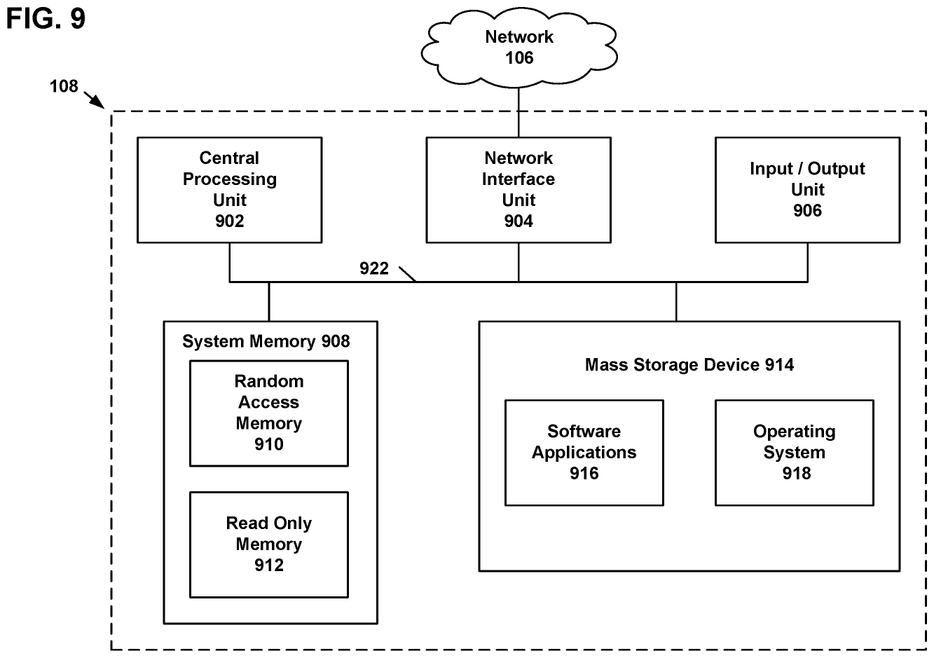

As illustrated in the example of FIG. 9, greeting card company server computing device 108 includes at least one central processing unit (“CPU”) 902, also referred to as a processor, a system memory 908, and a system bus 922 that couples the system memory 908 to the CPU 902. The system memory 908 includes a random access memory (“RAM”) 910 and a read-only memory (“ROM”) 912. A basic input/output system that contains the basic routines that help to transfer information between elements within the greeting card company server computing device 108, such as during startup, is stored in the ROM 912. The greeting card company server computing device 108 further includes a mass storage device 914. The mass storage device 914 is able to store software instructions and data. Some or all of the components of the greeting card company server computing device 108 can also be included in retailer server computing device 112 and the other computing devices described herein.

The mass storage device 914 is connected to the CPU 902 through a mass storage controller (not shown) connected to the system bus 922. The mass storage device 914 and its associated computer-readable data storage media provide non-volatile, non-transitory storage for the greeting card company server computing device 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the greeting card company server computing device 108.

According to various embodiments of the invention, the greeting card company server computing device 108 may operate in a networked environment using logical connections to remote network devices through the network 106, such as a wireless network, the Internet, or another type of network. The greeting card company server computing device 108 may connect to the network 920 through a network interface unit 904 connected to the system bus 922. It should be appreciated that the network interface unit 904 may also be utilized to connect to other types of networks and remote computing systems. The greeting card company server computing device 108 also includes an input/output controller 906 for receiving and processing input from a number of other devices, including a touch user interface display screen, or another type of input device. Similarly, the input/output controller 906 may provide output to a touch user interface display screen or other type of output device.

As mentioned briefly above, the mass storage device 914 and the RAM 910 of the greeting card company server computing device 108 can store software instructions and data. The software instructions include an operating system 918 suitable for controlling the operation of the greeting card company server computing device 108. The mass storage device 914 and/or the RAM 910 also store software instructions and software applications 916, that when executed by the CPU 902, cause the greeting card company server computing device 108 to provide the functionality of the greeting card company server computing device 108 discussed in this document. For example, the mass storage device 914 and/or the RAM 910 can store software instructions that, when executed by the CPU 902, cause the greeting card company server computing device 108 to display received data on the display screen of the greeting card company server computing device 108.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device for creating an electronic greeting card for a recipient, the method comprising:
receiving a selection of a theme and a message for the electronic greeting card;
receiving a selection of one or more retailers from which gifts can be obtained using the electronic greeting card;
receiving a recommendation for one or more products that can be selected by the recipient from at least one of the one or more retailers; and
integrating into the electronic greeting card the theme, the message, identifiers for each of the one or more retailers and identifiers for at least one of the one or more recommended products, the resulting electronic greeting card including:
an image corresponding to the theme;
selectable images of example credit cards of the one or more retailers at which purchases of the gifts using the electronic greeting card can be made, with the images of the example credit cards including branded retail credit cards that identify the one or more retailers; and
a secondary image, displayed upon selection of one of the example credit cards of the one or more retailers by the recipient, including a list of one or more products corresponding to the identifiers for at least one of the one or more recommended products associated with the retailer corresponding to the selected example credit card.

2. The method of claim 1, further comprising:
receiving a photograph from a purchaser of the electronic greeting card; and
integrating the photograph on the electronic greeting card with the selected theme, message and retailers.

3. The method of claim 1, further comprising:
receiving a selection of one or more filters that can be used to modify the photograph; and
integrating the one or more filters into the photograph.

4. The method of claim 1, further comprising:
creating an identifier for the electronic greeting card; and
storing the identifier on a storage device.

5. The method of claim 4, further comprising sending a notification to a recipient of the electronic greeting card, the notification including the identifier.

6. The method of claim 4, wherein the identifier comprises a hyperlink to a storage area that includes information regarding the electronic greeting card.

7. The method of claim 6, wherein the hyperlink when accessed by a recipient of the electronic greeting card activates a webpage from which the electronic greeting card can be activated.

8. The method of claim 1, further comprising:
receiving a notification from a retailer when an item associated with the electronic greeting card is purchased; and
making information regarding purchase of the item available to a purchaser of the electronic greeting card.

9. The method of claim 1, further comprising:
receiving a notification from a user device that the electronic greeting card has been accessed; and
after the notification is received, rendering on the user device one or more images of the recommended items for purchase.

10. The method of claim 1, further comprising:
receiving a selection of a filter for the electronic greeting card, the filter permitting an additional image to be added to the electronic greeting card; and
receiving a location for the additional image on the electronic greeting card.

11. The method of claim 1, further comprising:
receiving a first notification that an item has been obtained using the electronic greeting card;
receiving a dollar amount for the item that has been obtained;
reducing a dollar amount left for redemption on the electronic greeting card by the dollar amount for the item to obtain an updated dollar amount left for redemption; and
storing the updated dollar amount in a database.

12. The method of claim 11, further comprising sending a second notification to each of the one or more retailers of the updated dollar amount left for redemption.

13-19. (canceled)

20. An electronic computing device comprises:
a processing unit; and
system memory, the system memory including instructions which, when executed by the processing unit, cause the electronic computing device to:
receive a selection of a theme and a message for an electronic greeting card;
receive a photograph from a purchaser of the electronic greeting card;
receive a selection of one or more retailers from which gifts can be obtained by a recipient of the electronic greeting card using the electronic greeting card;
receive a list of recommended products for the recipient of the electronic greeting card from the purchaser of the electronic greeting card;
obtain a pointer to a storage area that includes information regarding the theme, message, photograph, selection of the one or more retailers and the list of recommended products for the electronic greeting card;
integrate into the electronic greeting card the theme, the message, the photograph, identifiers for each of the one or more retailers and the list of recommended products, the resulting electronic greeting card including:
an image corresponding to the theme;
selectable images of example credit cards of the one or more retailers at which purchases of the gifts using the electronic greeting card can be made, with the images of the example credit cards including branded retail credit cards that identify the one or more retailers; and
a secondary image, displayed upon selection of one of the example credit cards of the one or more retailers by the recipient, including a list of one or more products corresponding to the identifiers for at least one of the one or more recommended products associated with the retailer corresponding to the selected example credit card;
add a hyperlink to the electronic greeting card, the hyperlink providing a link to a website that can activate the electronic greeting card; and
send an email message or a text message to a recipient of the electronic greeting card, the email message or text message including the hyperlink.
